(19) United States
(12) Patent Application Publication
(10) Pub. No.: US 2026/0320373 A1
(43) Pub. Date: Oct. 15, 2026

(54) USER BEHAVIOR PREDICTION VIA GENERATIVE MODELING OF EVENT SEQUENCES

(71) Applicant: GOOGLE LLC, Mountain View, CA (US)

(72) Inventors: Moshe Lichman, Mountain View, CA (US); Josh Schroeder, Mountain View, CA (US); Michael Valenty, Mountain View, CA (US)

(21) Appl. No.: 18/859,865

(22) PCT Filed: Dec. 26, 2023
(86) PCT No.: PCT/US2023/085881

§ 371 Date: Oct. 24, 2024

(51) Int. Cl. G06N 3/08; G06N 3/0475

(52) U.S. Cl. CPC G06N 3/08; G06N 3/0475

(57) ABSTRACT

Systems and methods for generating customizable models for predicting user behavior are provided. Such a method includes: obtaining first structured event data representative of first events performed by one or more users; training a generative language model using the first structured event data; obtaining second structured event data representative of one or more second events performed by a user; and predicting, at least in part by applying the second structured event data as an input to the trained generative language model, third structured event data representative of behavior associated with the user according to one or more customizable analytic outputs.

### FIELD OF TECHNOLOGY

The present disclosure relates to generating models and, more specifically, to generating language models that utilize a non-human event language to predict user outcomes associated with events.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

In various use cases, it is desirable to generate models that are capable of predicting user outcomes, including behaviors, actions, results, and/or other user-focused determinations (e.g., for digital advertising, content design, layout optimization, etc.). While some models have such predictive capabilities, they are generally inflexible in that the models require retraining for the specific desired output and/or timeframe.

For example, in digital advertising, advertisers may want to determine whether a user is likely to perform a particular action and/or trigger a particular event. In traditional systems, a model may be trained to perform such an analysis. However, these techniques require that a unique model be trained for every timeframe of interest (e.g., a 7-day model, a 28-day model, etc.), every specific output of interest (e.g., a particular predicted user behavior), and so on.

### SUMMARY

In one example implementation, a method for generating customizable models for predicting user behavior includes: (i) obtaining, by a computing system, first structured event data representative of first events performed by one or more users; (ii) training, by the computing system, a generative language model using the first structured event data; (iii) obtaining, by the computing system, second structured event data representative of one or more second events performed by a user; and (iv) predicting, by the computing system and at least in part by applying the second structured event data as an input to the trained generative language model, third structured event data representative of behavior associated with the user according to one or more customizable analytic outputs.

In another example implementation, a computing system includes one or more processors and one or more non-transitory, tangible memories storing instructions. The instructions, when executed by the one or more processors, cause the computing system to: (i) obtain first structured event data representative of first events performed by one or more users; (ii) train a generative language model using the first structured event data; (iii) obtain second structured event data representative of one or more second events performed by a user; and (iv) predict, at least in part by applying the second structured event data as an input to the trained generative language model, third structured event data representative of behavior associated with the user according to one or more customizable analytic outputs.

### BRIEF DESCRIPTION OF THE DRAWINGS

FIG. 1 is a block diagram of an example system in which techniques for efficiently generating and training a model using event language can be implemented.

FIG. 2 depicts an example block diagram for training and outputting a prediction using a generative language model.

FIG. 3A depicts an exemplary process for embedding input features into vectors in a dimensional space for comparing and determining relationship between events.

FIG. 3B depicts an exemplary process for operating and/or training a sequential text generation model, where the output prediction is iteratively utilized as a next input value.

FIG. 4 depicts an exemplary large language model to be implemented in a generative device as described with regard to FIG. 1.

FIG. 5 is a flow diagram of an example method for using event language to train a model and generate predictions regarding user behavior.

### DETAILED DESCRIPTION OF THE DRAWINGS

In the disclosed invention, a generative language model (e.g., a large language model (LLM)) is trained on event data tokens rather than human language. The event data is structured according to grammatical rules of a non-human language, thereby allowing the generative language model to interpret and predict event data using techniques that are in some ways analogous to how existing generative language models interpret and predict human-language text. For example, the generative language model may treat a stream of distinct user experiences in a manner similar to a collection of documents, treat a user profile comprising multiple sessions in a manner similar to a single document, treat a session (e.g., an ordered grouping of closely related events) in a manner similar to a sentence or paragraph, and treat an event in a manner similar to a word or token. In some implementations, the disclosed invention uses long-distance dependency training techniques to train the generative language model.

The disclosed invention can use data indicative of particular events, and possibly associated metadata (e.g., data indicative of the relative timing of the events), to train a generative language model to generally understand event data and predict further/subsequent event data in a customizable way. For example, the generative language model may receive event data (e.g., via Google Analytics) associated with a user to generate a prediction regarding whether the user in question will exhibit a particular behavior (e.g., perform a particular action such as interacting with a website or ad in a particular manner) within a particular time window (e.g., the next hour, day, week, etc.), with both the behavior and the time window being customizable without retraining the model. Thus, the disclosed invention provides a flexible approach that can be modified (e.g., by an advertiser, or by an analytics team, etc.) relatively quickly and easily, without the delay and other costs associated with training a new model or retraining the existing model.

In particular, the disclosed invention avoids the need to retrain existing models for specific desired outputs, or to train entirely new models for specific desired outputs, by utilizing a generative language model rather than a conventional model to process structured event data. As referred to herein, “structured event data” may refer to event data structured according to one or more grammatical rules of a non-human language. Because generative language models are typically used to process human language, their use to process structured event data is non-intuitive. Advantageously, however, a generative language model can be trained to understand a sequence of input events and predict/output a sequence of arbitrary future events, with an arbitrary length (i.e., number of predicted events), without requiring new training or retraining for that specific output. For example, while a conventional model may need to be trained specifically to predict whether (e.g., a likelihood that) event A will occur after a past sequence of events, a generative language model can be trained more generally and can predict, for instance, whether event A will occur, whether event B will occur, whether events C then D will occur, and so on. In turn, the predicted future events or event sequences provide a rich source of information that can be processed in any desired manner (e.g., using various known analytics techniques) to predict or compute any particular outcome or metric. For example, if the generative language model predicts that a user who performed events A and B will next perform events X, Y, and Z, post-processing can be applied specifically to determine that the event XZ (i.e., a combination of X and Z) will likely occur, or to determine that event C will likely not occur, etc.

The event data can be structured and generated so as to include additional information beyond that included in human languages conventionally used to train standard generative language models, such as event times or relative timing between events. By training the generative language model on the additional information included in the structure of the event data, the model can exploit additional dimension(s) of information not possible with the conventional use of language models (i.e., when processing human language).

However, the differences between the structure of the event languages for the event data and conventional languages for training standard language models leads to unique challenges. In particular, (i) the event sequence length of the event data can differ from the length of training data for conventional language models, and (ii) the event structure and vocabulary cardinality of the event data differs from that of training data for conventional language models. Training data for conventional language models may include documents of related human text that can be or include hundreds or thousands of related word-tokens. The event data, however, may only be a few event-tokens long. For example, the user may load a news site, read an article, subscribe to a newsletter, and never return to the site. As such, there may be less event data with which to train the language model compared to conventional systems. Similarly, event data includes rich metadata, such as page URL, parameters (e.g., purchase amount), time elapsed after the previous event, type of computing device, etc. Training data for conventional language models does not include such rich metadata, and thus training the model should account for such.

As noted above, these differences can present challenges. For example, the shortened sequence lengths reduce the amount of available context the model can use in training, which is problematic because contextual token disambiguation is important for training many types of models (e.g., such as generative language models). Moreover, the deep event metadata structure can cause errors with vocabulary space. For example, a conventional English LLM may contain 30,000 unique sub-word tokens. With event data, multiplying the cardinality of each metadata dimension (e.g., URL, time gap, floating-point parameter values, etc.) can lead to a near-infinite number of unique tokens, each with potentially too few occurrences in the corpus of historical event data for effective learning. Furthermore, event metadata is not context that can be discarded after analysis and/or training. Instead, the model can generate predictions including new metadata for the event language output. This hierarchical generation is not part of conventional model architectures.

The instant techniques described herein overcome such challenges by remediating and exploiting these differences in the structure. For example, to address vocabulary cardinality, the computing system can produce embeddings of the event metadata components (e.g., as described herein). The encoded feature vectors become part of what the language model trains on and predicts. As such, by training a language model on data using a structure of the event data as described herein enables the dimensionality of each metadata component to become more tractable for such a vocabulary.

As a further example, to address challenges regarding short sequence length, and to enable the language model to produce complete events with all appropriate metadata, a computing system can further exploit the structure of the metadata. Encoding and representing each component separately allows reasonable predictive power of even short sequences since the model has access to all the contextually-related metadata tokens within a single event.

When generating output, some categories of metadata are easier to predict than others due to dimensionality differences. In particular, the metadata has an implicit hierarchy. The computing system can split the generation of the output event into generating each piece of the metadata in sequence, with latter components exploiting the already-predicted pieces. The more difficult to predict output pieces (e.g., URL embedding, or event name) can exploit the previously-made predictions of the more easy-to-generate, lower cardinality components for the event currently being generated. Put another way, the language model can avoid producing an event and associated metadata at once. In some such implementations, the language model instead takes as input both the previous, fully complete event tokens as well as a partially complete output token, with a subset of metadata populated. The computing system then iterates through all remaining metadata categories, adding a new prediction for one element of the metadata during each iteration.

In some implementations, the disclosed invention can additionally simulate a theoretical scenario to generate a predicted scenario outcome. For example, a computing system may propose, to the trained generative language model, a scenario in which the user returns to a site 24 hours after the user's last known/actual visit to the site, and then use the generative language model to predict the likelihood that, should that return visit in fact happen, the user will buy something within the following 3 days. Depending on the implementation, the simulated/theoretical scenario can be in the future (e.g., a future event the user may perform) or a branching past path (e.g., a hypothetical change to the past data).

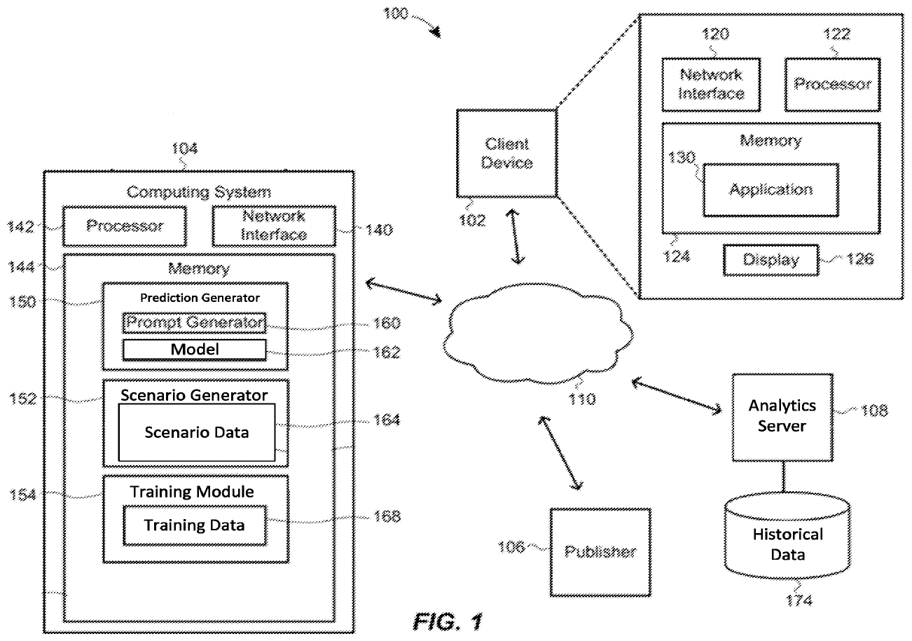

FIG. 1 illustrates an example system 100 in which one or more techniques for generating customizable models for predicting user behavior may be implemented. The example system 100 includes a client device 102, a computing system 104, a publisher 106, an analytics server 108, and a network 110. The computing system 104 in some implementations is remote from the client device 102 and/or analytics server 108, as well as communicatively coupled to the client device 102 and/or analytics server 108 via the network 110. The communicative/network connections shown in FIG. 1 for the publisher 106 represent communicative/network connections with computing devices or systems that are associated with the publisher 106. It will be understood that the example system 100 is exemplary, and that other systems may include additional, fewer, or alternative components. Similarly, arrangements of the components of system 100 may be modified. For example, some elements of system 100 may be combined, split apart, swapped, etc.

The network 110 may be a single communication network (e.g., the Internet), and in some implementations also includes one or more additional networks. As just one specific example, the network 110 may include a cellular network, the Internet, and a server-side local area network (LAN). While FIG. 1 shows only a single client device 102, publisher 106, and analytics server 108, it will be understood that the system 100 may include any suitable number of similar client devices, publishers, and/or content sponsors operating according to the principles disclosed herein.

Generally, the client device 102 can access one or more information resources supplied or published by the publisher 106, and the computing system 104 generates and trains a machine learning model to receive event data regarding a user at the client device 102 and subsequently generate a prediction regarding future behavior of the user according to data provided by the client device 102.

In some implementations, the information resources may be web pages of a website hosted by the publisher 106, and the analytics server 108 may analyze and/or store event data (e.g., from the client device 102) associated with user interactions with the information resources. Alternatively, the computing system 104 may include the analytics server 108 and/or store historical data associated with the user in addition to or in place of the analytics server 108.

In some implementations and/or scenarios, the computing system 104 (or another computing system not shown in FIG. 1) trains a machine learning model using the techniques as described herein. For example, the machine learning model may be a large language model (LLM) configured to receive event data in a non-human language directed to events. In some implementations, the event data may be comprised of one or more tokens indicating particular interactions (e.g., events) by a user with the information resources provided by the publisher 106.

As described herein, a non-human language may refer to a language that is not used for communication by humans or that a human is unable to naturally read. For example, a non-human language may be descriptive of events and their relative timing, and the non-human language may use events as individual tokens representative of interactions. Further, the events may be structured according to one or more grammatical rules (e.g., analogous to grammatical rules for human language). For example, the various events may be arranged in a sequence or session, indicative of events occurring in a single predetermined time period (e.g., in a single access of a website, in a single day, in a single hour, etc.). Similarly, multiple sessions may be arranged in a user profile corresponding to a user over a period of time, which may in turn be one of a series of user profiles in a stream of event data associated with a particular grouping including the user (e.g., based on location, based on device, based on age, etc.). Further, the non-human language may include metadata for the events (e.g., indicative of an event time signature, a relative time between events, a device ID associated with the event, a user ID associated with the event, a location associated with the event, a past user history associated with a user causing the event, etc.). Similarly, the non-human language may include an indication of event type as part of a grammatical rule.

In some implementations, the information resource with which the user interacts may be a screen/user interface/page of an application (e.g., a mobile app) provided by the publisher 106 or another entity to the client device 102 for installation, where the screen/user interface/page includes content slots that are to be populated (e.g., by computing system 104) with content (e.g., image content, video content, textual content, etc.). As another example, the information resource may be a video played by a video player of the client device 102, and the content slots may be distributed in time throughout the video.

The client device 102 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, the client device 102 includes a network interface 120, a processor 122, memory 124, and a display 126. The processor 122 may be a single processor (e.g., a central processing unit (CPU)), or may include a set of processors (e.g., multiple CPUs, or one or more CPUs and one or more graphics processing units (GPUs)).

The memory 124 includes one or more computer-readable, non-transitory storage units or devices, which may include persistent (e.g., hard disk) and/or non-persistent memory components. The memory 124 stores instructions that are executable by the processor 122 to perform various operations, including the instructions of various software applications and the data generated and/or used by such applications. In the example implementation of FIG. 1, the memory 124 stores at least an application 130, which may be, for example, a web browser application, a mobile application downloaded from an application store, or a video player application.

Generally, the application 130 is executed by the processor 122 to present information resources to the user of the client device 102 via the display 126 (and possibly one or more speakers of the client device 102, not shown in FIG. 1). In further implementations, at least one of the information resources includes one or more spatial and/or temporal content slots for dynamically presenting video content, image content, textual content, and/or any other such information resources. In an implementation where the application 130 is a web browser application, for instance, an information resource may be a web page hosted by the publisher 106, with the web browser causing the client device 102 to download HyperText Markup Language (HTML), scripts, and/or other code of the web page for presentation to a user via the display 126.

The display 126 includes hardware, firmware, and/or software configured to enable a user to view visual outputs of the client device 102, and may use any suitable display technology (e.g., LED, OLED, LCD, etc.). In some implementations, the display 126 is incorporated in a touchscreen having both display and manual input capabilities. Moreover, in some implementations where the client device 102 is a wearable device, the display 126 is a transparent viewing component (e.g., lenses of smart glasses) with integrated electronic components. For example, the display 126 may include micro-LED or OLED electronics embedded in lenses of smart glasses.

The network interface 120 includes hardware, firmware, and/or software configured to enable the client device 102 to exchange electronic data with the computing system 104 via the network 110. For example, the network interface 120 may include a cellular communication transceiver, a Wi-Fi transceiver, and/or transceivers for one or more other wired and/or wireless communication technologies.

While FIG. 1 shows client device 102 as a single component communicating directly (i.e., via network 110) with the computing system 104, in some implementations the subcomponents of client device 102 shown in FIG. 1 are instead divided among two or more user-side devices. As just one example, a pair of smart glasses may include the processor 122, the memory 124, and the display 126, while a smartphone may include another processing unit, another memory, another display, and the network interface 120. The smart glasses (or smart helmet, etc.) may then communicate as needed with the smartphone (e.g., via Bluetooth) to enable the operations described herein.

The computing system 104 includes a network interface 140, a processor 142, and memory 144. The network interface 140 includes hardware, firmware, and/or software configured to enable the computing system 104 to exchange electronic data with the client device 102 and other, similar client devices via the network 110. For example, the network interface 140 may include a wired or wireless router and a modem. The processor 142 may be a single processor, may include two or more processors, etc. The computing system 104 may include one or more servers, for example, which may reside at a single location or multiple locations.

The memory 144 is a computer-readable, non-transitory storage unit or device, or collection of units/devices, that may include persistent and/or non-persistent memory components. The memory 144 stores the instructions of a prediction generator 150, a scenario generator 152, and a training module 154, each of which may be executed by the processor 142. The prediction generator 150 includes a prompt generator 160 and a generative artificial intelligence (AI) and/or machine learning (ML) model 162. In some implementations, some of the software modules/units shown in FIG. 1 are omitted. For example, the prediction generator may omit the prompt generator 160, or the scenario generator 152 may be omitted in its entirety.

The prediction generator 150, scenario generator 152, and training module 154 are software modules comprising instructions executed by the processor 142 to generate, train, configure, and/or otherwise facilitate the production of an AI and/or ML model 162 (e.g., an LLM). The AI/ML model 162 is trained such that the AI/ML model 162 is able to read a customizable quantity of data associated with a user and generate a prediction for a similarly customizable future period. For example, the computing system 104 may generate and/or train the AI/ML model 162 to read data associated with a user from the previous 3 days, the previous 7 days, the previous 14 days, the previous 28 days, the previous month, etc. As another example, the computing system 104 may generate and/or train the AI/ML model 162 to predict user behavior over the next 3 days, the next 7 days, the next 14 days, the next 28 days, the next month, etc.

Generally, the prediction generator 150 generates a prediction regarding user behavior based on past behavior and using the AI/ML model 162, as described herein. Furthermore, the scenario generator 152 uses scenario data 164 (e.g., received from the publisher 106, the analytics server 108, the client device 102, and/or another computing device (not shown)) to implement additional scenarios in generating potential predictions. For example, the scenario generator 152 can receive scenario data 164 indicating a scenario in which the user returns to view the information resources 24 hours from the current time. The prediction generator 150 then alters the prediction accordingly.

Moreover, the training module 154 trains the AI and/or ML model 162 (e.g., including an LLM) using training data 168 as described herein. In some implementations, the training data is or includes data (e.g., historical data in historical data database 174) associated with the user. In further implementations, the training data is or includes data (e.g., historical data in historical data database 174) associated with other users. In still further implementations, the training data is or includes data (e.g., artificially generated historical data) provided by the publisher 106.

The operation of the prediction generator 150, the scenario generator 152, and the training module 154, and their constituent parts, will be discussed in further detail below in connection with various example implementations.

In the example implementation of FIG. 1, the analytics server 108 is communicatively coupled with a historical data database 174. In some implementations, the computing system 104 includes and/or is communicatively coupled with a database (not shown) for storing scenario data 164, training data 168, and/or other relevant forms of data. Depending on the implementation, each of the databases (e.g., historical data database 174 and/or databases for the scenario data 164, training data 168, etc.) may be stored in a local memory (e.g., the memory 144), or may be stored in memory remote from the coupled device/system.

The historical data database 174 includes event data generated, gathered, created, and/or otherwise stored by the analytics server 108, for example. In some implementations, the analytics server 108 interfaces with the publisher 106, computing system 104, and/or client device 102 to retrieve and/or generate event data. In other implementations, the analytics server 108 provides remote access to the computing system 104, and the computing system 104 generates and/or modifies the historical data before transmitting the data to the analytics server 108 for storage at the historical data database 174. In still other implementations, the historical data database 174 is stored/maintained by the computing system 104 rather than the analytics server 108. Therefore, in some such implementations, the computing system 104 may perform the functionality of the analytics server 108.

In some implementations, publishers (including publisher 106) hold accounts related to the services provided by the computing system 104. For example, the publishers may create such accounts in order to monetize information resources that they publish or otherwise make available (e.g., by selling advertising in content slots on the publishers' hosted web pages). In these implementations, information associated with the publisher accounts may be stored in an account database (not shown in FIG. 1). The account database may be stored in the memory 144, or may be stored in one or more memories that are remote from the computing system 104, for example. The account information may include information such as entity name, subscription level, entity preferences (e.g., brand control preferences), and so on. In some implementations, the account information includes selection parameters (e.g., bid amounts or maximum bid amounts) associated with different content sponsors, for use by the computing system 104 or a different computing system in selecting content for inclusion in content slots of publishers' information resources.

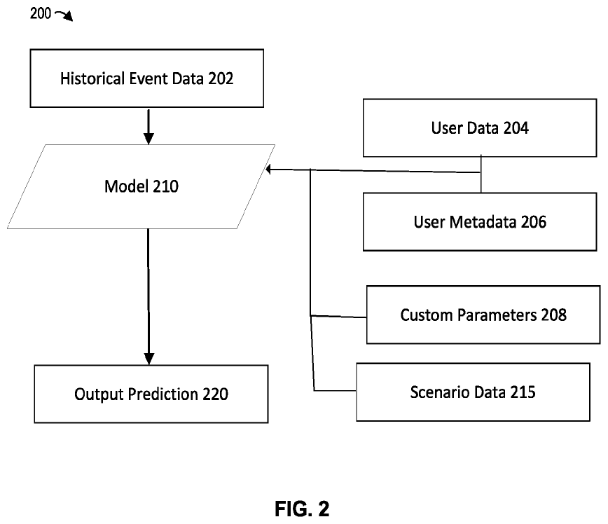

FIG. 2 depicts an example process 200 for generating an output such as an output prediction on user behavior by training and/or using a machine learning model (e.g., AI/ML model 162 of FIG. 1). The process 200 may be performed by the computing system 104 of FIG. 1 (e.g., by the processor 142 when executing instructions stored in memory 144), for example.

A model 210 (e.g., the AI/ML model 162) receives historical event data 202 (e.g., from the historical data database 174 of FIG. 1). In some implementations, the model 210 receives the historical event data 202 via an application programming interface (API) for the model 210 (e.g., running on the computing system 104, client device 102, analytics server 108, etc.).

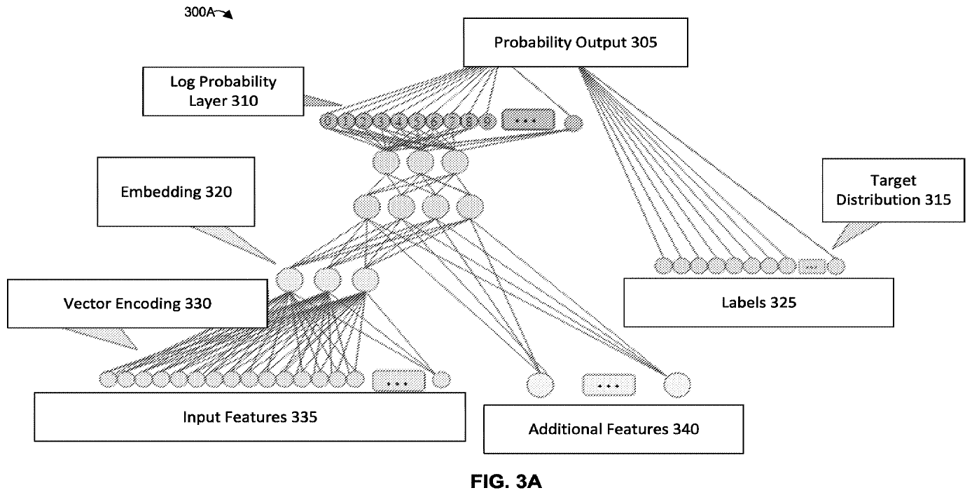

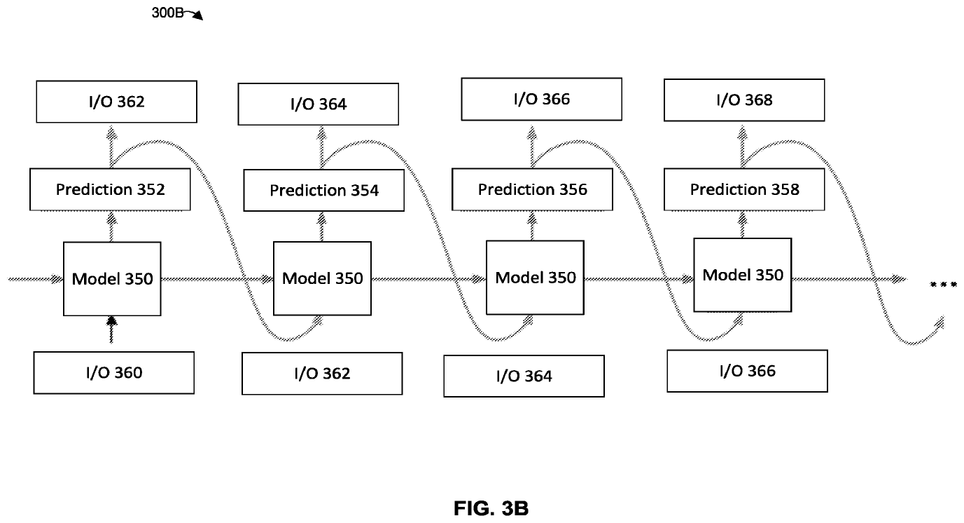

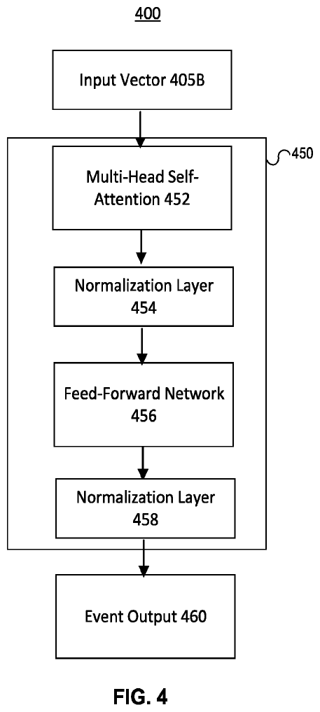

In some implementations, the model 210 is trained (e.g., by the computing system 104) using the historical event data 202. In particular, the historical event data 202 is structured to follow grammatical rules of a non-human language such as the event language described herein. Put another way, the computing system 104 is able to use the historical event data 202 without converting the data into a human readable language (e.g., English, French, Japanese, etc.), but instead analyzing the event data in a non-human language (e.g., in a native form). Depending on the implementation, the historical event data 202 can include labeled data (e.g., data with labels indicative of a next event in a sequence, an overall session/sequence context, etc.), unlabeled data, and/or any other data representative of past events. As such, the computing system 104 may train the model 210 according to supervised techniques (e.g., using the labeled data), unsupervised techniques (e.g., using the unlabeled data), semi-supervised techniques, etc. Training the model 210 is described in more detail with regard to FIGS. 3-4B below.

Although the historical event data 202 is not converted into a human readable language, the computing system 104 can train the model 210 using the historical event data 202 in a manner analogous to training a conventional LLM. For example, the model 210 can treat a stream of distinct user experiences in a manner similar to a collection of documents, treat a user profile comprising multiple sessions in a manner similar to a single document, treat a session (e.g., an ordered grouping of closely related events) in a manner similar to a sentence or paragraph, and treat an event in a manner similar to a word or token.

Moreover, the historical event data 202 includes metadata associated with events. The metadata includes information that is not present in human languages, such as relative time of events (e.g., how long between events occurring), a user identity (e.g., a user account ID, a user IP address (or a pseudonymous identifier functioning as a replacement for such), a user customer number, etc.), a user location, an indication of user event history (e.g., past events associated with the user), one or more device characteristics of a user device (e.g., client device 102), and/or other such metadata. As such, conventional models trained on human language data are less or not able to utilize such information.

Depending on the implementation, the model 210 may be or include a deep neural network and, more specifically, may be or include a large language model (LLM). The LLM may have a transformer model architecture with an encoder and decoder, and may tokenize inputs/text as described below with regard to FIGS. 4A and 4B. The transformer model may incorporate self-attention mechanisms to facilitate faster learning/training and/or more accurate output. In some implementations, the LLM includes many layers of neural networks, possibly including a number of embedding layers, a number of feedforward layers, and a number of recurrent layers. In some implementations, the model 210 includes a generative model other than an LLM. For example, the model 210 may instead include a less complex neural network.

The model 210 may have been trained by computing system 104 or another computing system using supervised or semi-supervised learning, and with training data (e.g., the historical event data 202) of the appropriate modality (i.e., event data). The model 210 may be a general-purpose model (e.g., trained on a wide array of publicly available datasets of event data) or may be a domain-specific model (e.g., trained on custom and/or proprietary datasets of event data).

The differences between the format of the event languages for the historical event data 202 and techniques for training conventional models leads to unique challenges in training the model 210 on the historical event data 202. In particular, (i) the event sequence length of the historical event data 202 can differ from the length of training data for conventional models, and (ii) the event structure and vocabulary cardinality of the historical event data 202 differs from that of training data for conventional models. Training data for conventional language models may include documents of related human text that can be or include hundreds or thousands of related word-tokens. The historical event data 202, however, may only be a few event-tokens long. For example, the user may load a news site, read an article, subscribe to a newsletter, and never return to the site. As such, the computing system 104 may have less event data with which to train the model 210 compared to conventional systems. Similarly, event data includes rich metadata, such as page URL, parameters (e.g., purchase amount), time elapsed after the previous event, type of computing device, etc. Training data for conventional systems does not include such rich metadata, and thus training the model 210 should account for such.

As noted above, these differences can present challenges. For example, the shortened sequence lengths reduce the amount of available context the model 210 can use in training, which is problematic because contextual token disambiguation is important for training many types of models (e.g., such as LLMs). Moreover, the deep event metadata structure can cause errors with vocabulary space. For example, a conventional English LLM may contain 30,000 unique sub-word tokens. With event data, multiplying the cardinality of each metadata dimension (e.g., URL, time gap, floating-point parameter values, etc.) can lead to a near-infinite number of unique tokens, each with potentially too few occurrences in the corpus of historical event data for effective learning. Furthermore, event metadata is not context that can be discarded after analysis and/or training. Instead, the model 210 can generate predictions including new metadata for the event language output. This hierarchical generation is not part of conventional language model architectures.

The instant techniques described herein overcome such challenges by remediating and exploiting these differences. For example, to address vocabulary cardinality, the computing system 104 can produce embeddings of the event metadata components (e.g., as described below with regard to FIG. 3A and FIG. 3B). The encoded feature vectors become part of what the model trains on and predicts. As such, the dimensionality of each metadata component can become more tractable for such a vocabulary.

As a further example, to address challenges regarding short sequence length, and to enable the model 210 to produce complete events with all appropriate metadata, the computing system 104 can exploit the structure of the metadata. Encoding and representing each component separately allows reasonable predictive power of even short sequences since the model has access to all the contextually-related metadata tokens within a single event.

When generating output, some categories of metadata are easier to predict than others due to dimensionality differences. In particular, the metadata has an implicit hierarchy. The computing system 104 can split the generation of the output event into generating each piece of the metadata in sequence, with latter components exploiting the already-predicted pieces. The more difficult to predict output pieces (e.g., URL embedding, or event name) can exploit the previously-made predictions of the more easy-to-generate, lower cardinality components for the event currently being generated. Put another way, the model 210 can avoid producing an event and associated metadata at once. In some such implementations, the model 210 instead takes as input both the previous, fully complete event tokens as well as a partially complete output token, with a subset of metadata populated. The computing system 104 then iterates through all remaining metadata categories, adding a new prediction for one element of the metadata during each iteration.

By adjusting the vocabulary space using embeddings, and iteratively generating the component pieces of the event's metadata, the computing system 104 provides model-based generation of event sequences.

In some implementations, the model 210 is an AI/ML model 162 stored at the computing system 104 (e.g., as depicted in FIG. 1). In further implementations, the model 210 is another model stored on a remote server and/or other component of system 100 (not shown) but accessed by the computing system 104. For example, the model 210 may be an LLM that a remote server makes available to computing systems (including computing system 104) via an application programming interface (API).

The model 210 additionally receives user data 204 and/or user metadata 206. Depending on the implementation, the user data 204 is data associated with a particular user (e.g., using the client device 102). The user metadata 206 may include metadata as described above with regard to the historical event data 202 metadata. The user data 204 and user metadata 206 are similarly in the same non-human language and follow the same grammatical structure as the historical event data 202.

The model 210 then uses the user data 204 and user metadata 206 to perform various tasks regarding the user, such as generating an output prediction 220 (e.g., including an output scenario). For example, the model 210 can utilize the user data 204 over a particular period of time to determine an output prediction 220 regarding user behavior in a window. The output of the model 210 may be customized based on custom parameters 208 received at the model 210. Depending on the implementation, the custom parameters 208 may indicate a type of prediction or other operation (e.g., predicting a likelihood of a user performing a specified event or action, predicting a likelihood of the user triggering an event, determining a number of expected users in a time period, determining a specific revenue prediction associated with the user etc.), a window in which the user is predicted to perform the operation (e.g., 3 days, 7 days, 28 days, one month, etc.), and/or any other such parameter.

In traditional systems, a computing system may generate a model to perform such an analysis. However, by generating a model according to conventional techniques, a unique model must normally be generated and trained for every timeframe (e.g., a 7-day model, a 28-day model, etc.), metric (e.g., predicted user behavior, branching scenarios in user history, etc.), and/or other such outcome desired. By training the model 210 on event data as described herein, the computing system 104 can generate, train, and otherwise provide a single model with customizable capabilities.

In some implementations, the computing system 104 additionally simulates a theoretical scenario to generate an output scenario as part of the output 220. In particular, the model 210 uses scenario data 215 to modify, augment, replace, and/or otherwise adjust the user data 204 for the model 210 to generate the output scenario. For example, the computing system 104 can provide scenario data 215 representative of a scenario in which the user returns to a site 24 hours after the user's last known or actual visit to the site, and the computing system 104 (e.g., via the model 210) can then predict an output scenario representative of a likelihood that, should that return visit in fact happen, the user will buy something within the following 3 days. Depending on the implementation, the output scenario can be based on scenario data 215 representative of the future (e.g., a future event the user may perform) or a branching past path (e.g., a hypothetical change to the past data).

FIG. 3A depicts a process 300A, for embedding input data while training a machine learning model, according to one implementation. Depending on the implementation, the process 300A may be performed by the computing system 104 of FIG. 1 (e.g., by the processor 142 when executing instructions stored in memory 144), for example.

To generate the embeddings for input data, the computing system 104 receives one or more input features 335 (e.g., the historical data and/or user data as described herein). The computing system 104 then generates one or more vector encodings 330 representative of the input features. The computing system 104 generates a D-dimensional (e.g., 2D, 3D, 4D, etc.) space indicative of similarity between the input features 335 vector encodings 330. The computing system 104 plots the vector encodings 330 in the D-dimensional space to generate the embeddings 320. In some implementations, the computing system 104 also generates encodings for additional features 340 of the event data. For example, the additional features 340 may include metadata associated with the one or more input features 335 (e.g., a location of a device associated with the user, an event time, an account ID associated with the user, a time of day, a time of week, observable device information (e.g., mobile or desktop, browser, specific device type, device language, etc.), user origin (search engine, direct link, ad interaction, etc.), demographic information for a user, a tier for a user (e.g., in a loyalty reward program), a membership start date for a user, a lifetime value of a user, past behavior of a user, a device type for a device, a screen size for a device, a browser type for a device, a location for a device (e.g., country or region), a URL of a webpage, a page title or screen name for a webpage, content on a webpage (e.g., products shown), known metadata about products (e.g., price or category), a type of business associated with a publisher, a name or type of event, a time of an event (e.g., day, week, month, year) parameters associated with the event, and/or any other such features). In other implementations, the computing system refrains from generating encodings for additional features 340. Depending on the implementation, the embeddings 320 are representative of one or more long distance dependencies for tokens in the event language. The computing system 104 may utilize the embeddings 320 (and, by extension, the long distance dependencies) in training a model, as described with regard to FIGS. 4A and 4B, herein.

In some implementations, the computing system 104 further generates a log probability layer 310 representative of a probability distribution of likelihood for various next outcomes (e.g., determined next events in a sequence). The computing system 104 determines the probability output 305 based on the embedding layer(s). In further implementations, the computing system 104 determines the probability output 305 using one or more labels 325 associated with the input features to teach a model to embed the input data.

FIG. 3B depicts an exemplary process 300B for operating and/or training a sequential text generation model, where the output prediction is iteratively utilized as a next input value. In particular, a model 350 receives an initial input/output value (e.g., I/O 360) and performs a prediction 352 to generate an I/O 362. The I/O 362 is fed into the model 350 and another prediction 354 is performed to generate an I/O 364. The process is iteratively repeated, with each I/O being fed in to the model 350 to perform a prediction (e.g., prediction 352, 354, 356, 358, etc.) and output an I/O value (e.g., I/O 362, 364, 366, 368, etc.) that is subsequently used as an input to the model 350. In such a way, the model is able to iteratively predict larger strings of events, as described herein. Depending on the implementation, the prediction may be a multinomial distribution process and/or another classification process as described with regard to FIG. 4 below.

Depending on the implementation, the model 350 may be or include neural networks, such as artificial neural networks (ANN), convolution neural networks (CNN), or recurrent neural networks (RNN). In further implementations, the model 350 may incorporate, include, be, and/or otherwise use techniques in a manner reminiscent to language model techniques (e.g., a large language model (LLM), a bag-of-words model, etc.). For example, the model 350 may utilize events such that the model 350 treats a stream of distinct user experiences in a manner similar to a collection of documents, treats a user profile comprising multiple sessions in a manner similar to a single document, treats a session (e.g., an ordered grouping of closely related events) in a manner similar to a sentence or paragraph, and treats an event in a manner similar to a word or token. Similarly, the model 350 may incorporate, include, be, and/or otherwise use a transformer architecture to utilize the appropriate language model techniques, as described with regard to FIG. 4 below.

FIG. 4 illustrates an exemplary large language model 400 trained as a generative model as described herein. In particular, the generator model 410 receives an input vector 405 and outputs an output 460. In some implementations, the input vector 405 may be a fixed-length random vector. In further implementations, the input vector 405 may be drawn randomly from a Gaussian distribution such that points in the vector space corresponding to the input vector 405 may correspond to points in the problem domain representative of the data distribution (e.g., as described with regard to FIG. 3A and FIG. 3B). Depending on the implementation, the vector space corresponding to the input vector 405 may include one or more hidden variables (e.g., variables that are not directly observable). In some implementations, the input vector 405 may be used to seed the generative process.

In some implementations, the generative AI and/or ML model may be based upon an LLM trained to predict an event in a sequence of events. For example, the LLM may be trained to predict a next event following a given sequence of events. For instance, the generative AI and/or ML model may be given the sequence “(i) visit webpage; (ii) wait 3 days; (iii) visit webpage; and (iv) purchase item from webpage,” and the generative AI and/or ML model may predict a next event, such as “return to webpage in 3 days”, “purchase another item”, “do not return to the webpage”, etc.

Advantageously, some implementations use transformers in training the model (e.g., by using a generative pre-trained transformer (GPT) model). More specifically, some implementations use a GPT model that includes (i) an encoder that processes the input sequence, and (ii) a decoder that generates the output sequence. The encoder and decoder may both include a multi-head self-attention mechanism that allows the GPT model to differentially weight parts of the input sequence to infer meaning and context (e.g., using metadata in the historical and/or training data).

In particular, the input vector 405 may be a vector representative of relationships between events, sequences, etc. in the input. The large language training module 450 may include a self-attention block 452 component to attend to different parts of the input simultaneously or near-simultaneously to capture relationships and/or dependencies between the different parts of the input (e.g., referred to as a multi self-attention block, multi-head attention block, multi-head self-attention block, masked multi self-attention block, masked multi-head attention block, masked multi-head self-attention block, etc.). In particular, the self-attention block 452 relates different positions of a sequence to compute a representation of the sequence. As such, the self-attention block 452 may weigh an impact of different events in a sequence when sequencing. As such, the model 400 learns to give emphasis to different portions of an input vector 405. In some implementations, the model 400 uses metadata related to the events in place of and/or at the self-attention block 452 to determine impact and/or relationship between events within the sequence.

The self-attention block 452 may then compute an attention score representing the impact of each word in the sentence with respect to the other words in the sentence (e.g., by taking a dot product between different vector sets). The output then proceeds to the normalization layer 454. The normalization layer 454 may normalize the output of the self-attention block 452 (e.g., by applying a softmax function to normalize the scores).

Similarly, the self-attention block may subsequently output into a feed-forward network block 456, which performs a non-linear transformation to generate a new representation of the input and/or relationships between events, sequences, etc. In particular, the feed-forward network block 456 may compute a weighted sum of the vectors, using the calculated and normalized attention scores to capture the contextual relationships between words. In some implementations, the normalization layer 454 and/or the self-attention block 452 may perform the computation to generate a representation of the relationship between words, etc. After the feed-forward network block 456, an additional normalization layer 458 may normalize the respective output and/or add residual connection(s) to allow the output to move directly to another input. The model 400 may therefore learn which parts of an input are important (e.g., remain prevalent through the normalization process). Depending on the implementation, the model 400 may repeat the process for the large language training module 450 1 time, 5 times, 10 times, N times, etc. to train the respective model(s).

Depending on the implementation, an encoder and/or a decoder may be trained as described above. In further implementations, the encoder is trained in accordance with the above, and a decoder includes an additional self-attention block (not shown) receiving the output of the encoder as well.

Furthermore, in some implementations, rather than performing the previous four steps only once, the GPT model iterates the steps and performs them in parallel; at each iteration, new linear projection of the query, key, and value vectors are generated. Such iterative, parallel implementations advantageously improve grasping of sub-meanings and more complex relationships within the input sequence data.

Further advantageously, some implementations train and/or tune the model using supervised, unsupervised, and/or semi-supervised techniques. For example, the model may be trained using labels associated with the events to allow the model to recognize the “correct” answer in a pattern for a sequence (e.g., for supervised training). Further, the computing system 104 may train the model using reward techniques, reinforcement techniques, and/or any other such techniques as adapted to the event data described herein.

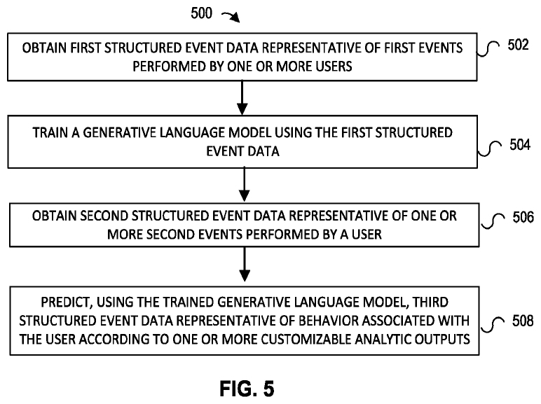

FIG. 5 is a flow diagram of an example method 500 for generating customizable models for predicting user behavior. The method 500 may be implemented as instructions stored on one or more computer-readable media and executed by one or more processors in one or more computing devices. For example, the method 500 may be implemented by the processor 142 of the computing system 104 in FIG. 1, when executing instructions of the prediction generator 150, scenario generator 152, training module 154, and/or any other such module as described herein. As a further example, the method 500 may be implemented by one or more processors of a computing device communicatively coupled to the computing system 104. It will be understood that any such implementation is exemplary, and that additional, fewer, and/or alternate components may be used to implement the example method 500.

At block 502 of the method 500, the computing system 104 obtains first structured event data representative of one or more first events. Additionally, in the implementation of method 500, the first structured event data is in a non-human language and is structured according to the grammatical rules of the non-human language. In some implementations, the first structured event data includes historical event data (e.g., historical event data 202 and/or historical data in historical data database 174) used to train a machine learning model (e.g., training data). The first structured event data follows grammatical rules of a non-human event-focused language and is not translated into a human language (e.g., English, French, Japanese, etc.). In the exemplary implementation of FIG. 5, the grammatical rules include an overall structure for the language. For example, the various events may be arranged in a sequence or session, indicative of events occurring in a single predetermined time period (e.g., in a single access of a website, in a single day, in a single hour, etc.). Similarly, multiple sessions may be arranged in a user profile corresponding to a user over a period of time, which may in turn be one of a series of user profiles in a stream of event data associated with a particular grouping including the user (e.g., based on location, based on device, based on age, etc.).

Depending on the implementation, the first structured event data may be or include data representative of one or more interactions with an application, views of a webpage, hits on a landing page for a domain, interactions with a purchase button, entering personal information (e.g., credit card information, address information, email information, etc.), receipts of a notification, opening a notification, and/or any other such interaction with material from a publisher 106, application developer (not shown), computing system 104, etc. In further implementations, the first structured event data includes metadata associated with the one or more events. For example, the first structured event data may include relative time of events (e.g., how long between events occurring), a user identity (e.g., a user account ID, a user IP address, a user customer number, etc.), a user location, an indication of user event history (e.g., past events associated with the user), one or more device characteristics of a user device (e.g., client device 102), and/or other such metadata.

At block 504, the computing system 104 trains a generative language model (e.g., AI/ML model 162 and/or model 210) using the first structured event data. As described above with regard to block 502, the first structured event data is in a non-human language directed to events. As such, the computing system 104 trains the generative language model to read and analyze data in the non-human language. More particularly, the computing system 104 trains the generative language model on event sequences (e.g., from an analytics server such as analytics server 108 of FIG. 1). In implementations in which the first structured event data includes metadata, the computing system 104 additionally trains the generative language model using the metadata. For example, the computing system 104 can train the generative language model to understand relative time between events and determine whether user behavior correlates with the relative time between events based on the metadata.

As such, in some implementations, the computing system 104 trains a single model to be capable of directly answering a wide variety of predictive questions without adapting and fine-tuning to a specific task. For example, the computing system 104 may feed the generative language model a novel user's event stream and prompt the model to generate the most likely events for a given window (e.g., 3 days, 7 days, 28 days, etc.) based on the input. The computing system 104 may then search the generated stream for key future events generated by the model (e.g., will the user convert (e.g., purchase an item), what will the lifetime value for a user be, will the user churn (cease interaction with the content), etc.).

In further alternative implementations, the computing system 104 trains the generative language model initially and performs fine-tuning to the generative language model to perform various tasks and/or predict various operations without training an entirely new model. For example, the computing system 104 trains a large generative language model on an initial goal (e.g., next event prediction). After completing the base model, the computing system 104 fine-tunes separate individual task-oriented models (e.g., probability of converting (e.g., purchasing an item) in the next week), by using the encoded output of the base model as an input. As such, the computing system 104 can develop new task-specific models at greater speed than by individually generating each model. In further implementations, the computing system 104 trains a single model to perform the various tasks and fine-tunes task-specific models based on publisher data sharing settings (e.g., if the publisher (e.g., publisher 106) does not consent to sharing data with other publishers).

At block 506, the computing system 104 obtains second structured event data representative of one or more second events performed by a user. The second structured event data is in the same non-human event language as the first structured event data and is therefore structured according to similar grammatical rules. Further, depending on the implementation, the second structured event data includes information similar to the first structured event data, but for a particular user. In further implementations, the second structured event data includes event data for a user group that includes the user (e.g., users that access a webpage from the same IP address, users that access an application on the same device, users fitting an age range, location, or other demographic information that purchase an item, etc.).

At block 508, the computing system 104 predicts, using the generative language model, third structured event data representative of behavior associated with the user according to one or more customizable analytic outputs. The third structured event data, similar to the first structured event data and second structured event data, is in a non-human language and is structured according to grammatical rules based on the non-human language. As such, the generative language model does not transform the third structured event data to a human language (such as English, French, Japanese, etc.) for the analysis. The third structured event data may be or include predicted user behavior, a predicted outcome to a hypothetical scenario, a predicted outcome to an altered history scenario (e.g., where the computing system 104 adds, modifies, replaces, or otherwise adjust past event data), etc. In some implementations in which the second structured event data includes stream data for at least one client device representative of one or more sessions of user events (e.g., stream data for multiple users), predicting the user behavior includes extracting user events for a particular user from the stream data (e.g., via a user ID, one or more user characteristics, an event data ID, etc.). The computing system 104 then uses the trained generative language model to predict at least one future event based on the extracted user events. In some implementations, predicting the at least one future event includes determining, by the trained generative language model, a likelihood of occurrence for the at least one future event to occur.

In some implementations, the one or more customizable analytic outputs are or include various metrics for customizing the output analysis. For example, the customizable analytic outputs can be or include a time window for the analysis, particular types of analysis (e.g., detecting likelihood of user retention, predicting future purchases and/or revenue prediction associated with the user, determining potential for user to refer others to the site, etc.), a user identity (e.g., when the second structured event data includes data for a stream of user profiles), and/or any other such metric. In further implementations, some of the metrics and analysis are determined and performed at a post-processing step (e.g., as described below), and the customizable analytic output is a stop token for indicating where the generation of the third structured event data is to end.

The second structured event data (e.g., including the user data) includes an initial set of events to prompt the generative language model to generate the third structured event data. In some implementations, the second structured event data continues to feed automatically into the model, causing the generative language model to generate the third structured event data in real-time or near-real-time. In further implementations, the model receives the second structured event data in discrete packets, and generates the third structured event data responsive to receiving the packet(s) and/or to receiving an indication from a publisher and/or other content owner. The model may generate the third structured event data to an arbitrary length until reaching a customizable point as indicated by a stop token and/or other such indication to stop generating data in the second structured event data (e.g., after 3 days of expected behaviors, 7 days of expected behavior, 28 days of expected behavior, etc.). The computing system 104 or analytics server 108 may perform a post-processing step to adjust a window of time for which relevant data is to be displayed and/or used as answering a prompt. In some implementations, the post-processing step may be or include pre-existing and/or conventional analytics techniques (e.g., the computing system 104 or analytics server 108 may operate on the predicted event sequence using techniques for conventional historical event data). In further implementations, the post-processing step may be or include analytics techniques customized for the third structured event data and/or a combination of customized and conventional techniques. As an example, the computing system 104 may generate predictions for user behavior for a month or more, but the window of time may be 3 days. In some implementations, the window is based on a number of events, whether a particular event occurs, a period of time, and/or any other such window.

In some implementations, the computing system 104 inserts, replaces, modifies, and/or otherwise adjusts event data using scenario data. Depending on the implementation, the scenario data can be theoretical and forward-looking or branching and backward-looking. For example, the scenario data may be or include a theoretical scenario in which the computing system 104 determines a likelihood of the user purchasing an item if the user visits the webpage sometime in the next 3 days. As another example, the scenario data may be or include a branching scenario in which the computing system 104 determines what the likelihood of the user purchasing an item would have been if the user interacted with an ad 2 days prior. As such, the computing system 104 can dynamically ask and answer any questions related to the user data without training a new model. Depending on the implementation, the computing system 104 can receive a prompt from the publisher (e.g., analytics server 108) and/or other owner of content displayed to a user (e.g., a webpage, application, media, etc.) and generate event data representative of the event to insert into the generative language model as scenario data.

In some implementations, the computing system 104 uses the same trained generative language model to determine an alternative output without modifying the model itself. In particular, the computing system 104 can predict, at least in party by applying the second structured event data as an input to the trained generative language model, fourth event data (e.g., different than the third structured event data) representative of behavior associated with the user according to a second set of customizable analytic outputs different than the first set of customizable analytic outputs. Depending on the implementation, the second set of customizable analytic outputs can be of a different type (e.g., a time window compared to a type of analysis) or the same.

In some implementations, the computing system 104 receives one or more event or metric prompts from the publisher and/or other owner of content displayed to a user (e.g., a webpage, application, media, etc.) for predicting user behavior or some other outcome. In further implementations, the computing system 104 includes an additional model to convert an input from the publisher and/or other owner of content to an event prompt and/or metric. Similarly, the computing system 104 may include a separate model to convert the third structured event data to a human language (e.g., English, French, Japanese, etc.) in a post-processing step.

In further implementations, the computing system 104 generates a confidence score representative of a potential accuracy of the third structured event data. Depending on the implementation, the computing system 104 may generate the confidence score based on a similarity to historical event data (e.g., first structured event data used to train the generative language model). For example, the computing system 104 may determine a complete confidence score (e.g., of 100% or near 100%) if the prediction happens every time and has occurred multiple times in the historical event data, and only a 50% confidence score if the prediction happens 50% of the time. Similarly, the computing system 104 may otherwise generate the confidence score based on other factors, such as frequency of occurrence in historical event data, similarity between the user data and historical event data, past knowledge of the user, etc.

In some implementations, and as noted above, the techniques disclosed herein use artificial intelligence to facilitate the efficient generation of a stream of event data (e.g., representative of a predicted outcome). Artificial intelligence (AI) is a segment of computer science that focuses on the creation of models that can perform tasks with little to no human intervention. Artificial intelligence systems can utilize, for example, machine learning and computer vision. Machine learning, and its subsets, such as deep learning, focus on developing models that can infer outputs from data. The outputs can include, for example, predictions and/or classifications. Computer vision focuses on analyzing and interpreting images and videos. Artificial intelligence systems can include generative models that generate new content in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data and may be further updated or refined during their use based on additional feedback/inputs.

In some implementations, the computing system 104 may use any one or more the machine learning models noted above to perform any one or more of the operations discussed herein in connection with machine learning. For example, the computing system 104 may use one or more such machine learning models to generate a stream of event data, as discussed above.

Although the foregoing text sets forth a detailed description of numerous different aspects and implementations of the invention, it should be understood that the scope of the patent is defined by the words of the claims set forth at the end of this patent. The detailed description is to be construed as exemplary only.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present) and B is true (or present), and both A and B are true (or present).

Upon reading this disclosure, those of skill in the art will appreciate still additional alternative structural and functional designs for predicting user behavior through customizable event modeling and using a non-human language, through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

1. A method for predicting user behavior with customizable event modeling, the method comprising:
obtaining, by a computing system, first structured event data representative of first events performed by one or more users;
training, by the computing system, a generative language model using the first structured event data;
obtaining, by the computing system, second structured event data representative of one or more second events performed by a user; and
predicting, by the computing system and at least in part by applying the second structured event data as an input to the trained generative language model, third structured event data representative of behavior associated with the user according to one or more customizable analytic outputs.

2. The method of claim 1, wherein the second structured event data includes metadata associated with the one or more second events, and wherein predicting the behavior associated with the user is further based on the metadata.

3. The method of claim 2, wherein the one or more second events include a plurality of events, and wherein the metadata includes metadata representative of relative timing of a first event of the plurality of events compared to a second event of the plurality of events.

4. The method of claim 2, wherein the metadata includes at least one of: (i) a user identity; (ii) a user location; (iii) an indication of user event history; or (iv) one or more device characteristics.

5. The method of claim 2, wherein predicting the third structured event data includes:
encoding, by the computing system, one or more embeddings for features associated with the one or more second events and the metadata.

6. The method of claim 5, wherein each of the one or more embeddings is representative of a respective one of the one or more second events and all metadata of the metadata that is associated with the respective one of the one or more second events.

7. The method of claim 2, wherein predicting the third structured event data includes:
generating, by the computing system, a first portion of the third structured event data based on the metadata; and
generating, by the computing system, a second portion of the third structured event data based on the first portion of the third structured event data.

8. The method of claim 1, wherein training the generative language model includes training the generative language model based on one or more long distance dependencies.

9. The method of claim 1, wherein the second structured event data includes stream data for the user representative of one or more sessions of user events and predicting the behavior associated with the user includes:
extracting the user events from the stream data; and
predicting, by the trained generative language model, at least one future event based on the extracted user events.

10. The method of claim 1, further comprising:
applying, as a part of the input to the trained generative language model, an indication of a theoretical future event;
wherein predicting the behavior associated with the user is further based on the theoretical future event.

11. The method of claim 1, wherein the second structured event data includes historical event data associated with the user.

12. The method of claim 1, wherein the second structured event data includes theoretical branching event data associated with the user.

13. The method of claim 1, wherein the first events and the one or more second events include at least one of: (i) a webpage view; (ii) a landing page hit; (iii) a hit associated with an interactive element of a webpage; (iv) a hit associated with an interactive element of an application; (v) receiving a notification; or (vi) opening a notification.

14. The method of claim 1, wherein the one or more customizable analytic outputs are a first set of customizable analytic outputs, and wherein the method further comprises:
predicting, by the computing system and at least in part by applying the second structured event data as an input to the generative language model, fourth event data representative of behavior associated with the user according to a second set of customizable analytic outputs different than the first set, wherein the fourth event data is different from the third structured event data.

15. A computing system configured to predict user behavior with customizable event modeling, the computing system including:
one or more processors; and
a memory storing instructions that causes the computing system to:
obtain first structured event data representative of first events performed by one or more users;
train a generative language model using the first structured event data;
obtain second structured event data representative of one or more second events performed by a user; and
predict, at least in part by applying the second structured event data as an input to the trained generative language model, third structured event data representative of behavior associated with the user according to one or more customizable analytic outputs.

16. The computing system of claim 15, wherein the second structured event data includes metadata associated with the one or more second events, and wherein predicting the behavior associated with the user is further based on the metadata.

17. The computing system of claim 16, wherein the one or more second events include a plurality of events, and wherein the metadata includes metadata representative of relative timing of a first event of the plurality of events compared to a second event of the plurality of events.

18. The computing system of claim 16, wherein the metadata includes at least one of: (i) a user identity; (ii) a user location; (iii) an indication of user event history; or (iv) one or more device characteristics.

19. The computing system of claim 16, wherein predicting the third structured event data includes:
encoding one or more embeddings for features associated with the one or more second events and the metadata.

20. The computing system of claim 16, wherein predicting the third structured event data includes:
generating a first portion of the third structured event data based on the metadata; and
generating a second portion of the third structured event data based on the first portion of the third structured event data.
